(19) United States
(12) Patent Application Publication
(10) Pub. No.: US 2025/0360430 A1
(43) Pub. Date: Nov. 27, 2025

(54) Block set

(71) Applicant: Sony Interactive Entertainment Inc., Tokyo (JP)

(72) Inventor: Naoki OGISHITA, Tokyo (JP)

(73) Assignee: Sony Interactive Entertainment Inc., Tokyo (JP)

(21) Appl. No.: 19/201,596

(22) Filed: May 7, 2025

Related U.S. Application Data
(60) Provisional application No. 63/651,083, filed on May 23, 2024.

(51) Int. Cl. A63H 33/04; G09B 1/38

(52) U.S. Cl. CPC A63H 33/046; G09B 1/38

(57) ABSTRACT

A block set includes a smallest size block that has a cubic shape, with one side exceeding 2.5 cm, and a plurality of blocks that have a larger volume than the smallest size block, are circumscribed by a rectangle with a minimum side exceeding 2.5 cm, and have the same height from a bottom surface to a top surface. The smallest size block and the blocks each have a plurality of magnets that are disposed on lateral surfaces with different poles facing outward.

### BACKGROUND

The present disclosure relates to a set of combination blocks.

Sets of blocks that can be coupled together by magnetic force to create various shapes for enjoyment are widely known, for example, as educational toys.

### SUMMARY

However, in order to diversify the configuration of shapes of such block sets, the size of each block is typically small. This makes them unsuitable for small children as they may accidentally be ingested. Further, block sets of the existing technology include a large number of types of blocks in order to be able to represent various shapes including a corporate logo and the design motif of a specific product.

The present disclosure has been made in view of the above circumstances. It is desirable to provide a set of blocks that reduces the possibility of accidental ingestion and that is able to represent corporate logos and other designs while it includes a relatively small number of types of blocks.

According to an embodiment of the present disclosure, there is provided a block set. The block set includes a smallest size block that has a cubic shape, with one side exceeding 2.5 cm, and a plurality of blocks that have a larger volume than the smallest size block, are circumscribed by a rectangle with the minimum side exceeding 2.5 cm, and have the same height from a bottom surface to a top surface. The smallest size block and the blocks each have a plurality of magnets that are disposed on lateral surfaces with different poles facing outward.

The above-described embodiment of the present disclosure makes it possible to reduce the possibility of accidental ingestion and represent corporate logos and other designs.

### BRIEF DESCRIPTION OF THE DRAWINGS

FIGS. 1A and 1B present a perspective view and a plan view that illustrate one of block groups according to an example of an embodiment of the present disclosure;

FIGS. 2A and 2B present a perspective view and a plan view that illustrate another block group according to the example of the embodiment of the present disclosure;

FIGS. 3A and 3B present a perspective view and a plan view that illustrate still another block group according to the example of the embodiment of the present disclosure;

FIGS. 4A and 4B present a perspective view and a plan view that illustrate yet another block group according to the example of the embodiment of the present disclosure;

FIG. 5 is an explanatory diagram illustrating an example of a character string formed by a block group according to the example of the embodiment of the present disclosure;

FIG. 6 is an explanatory diagram illustrating examples of, for instance, characters that can be formed by a block group according to the example of the embodiment of the present disclosure;

FIGS. 7A to 7E present a set of explanatory diagrams illustrating blocks according to an additional example of the embodiment of the present disclosure; and

FIGS. 8A and 8B present a set of explanatory diagrams illustrating examples of the use of blocks according to the additional example of the embodiment of the present disclosure.

### DETAILED DESCRIPTION OF THE PREFERRED EMBODIMENT

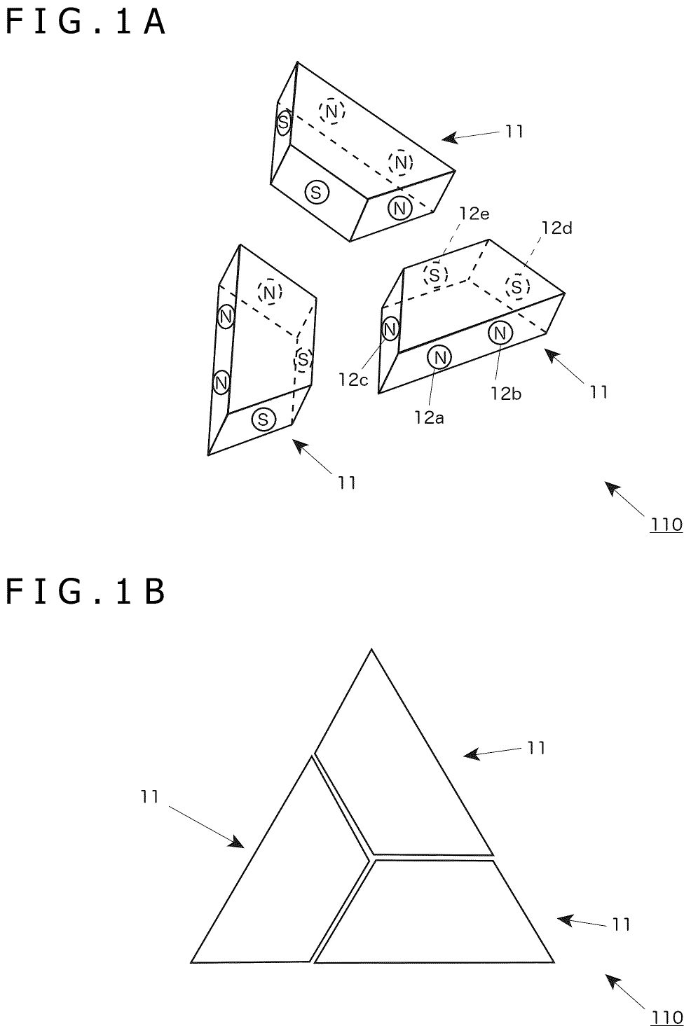

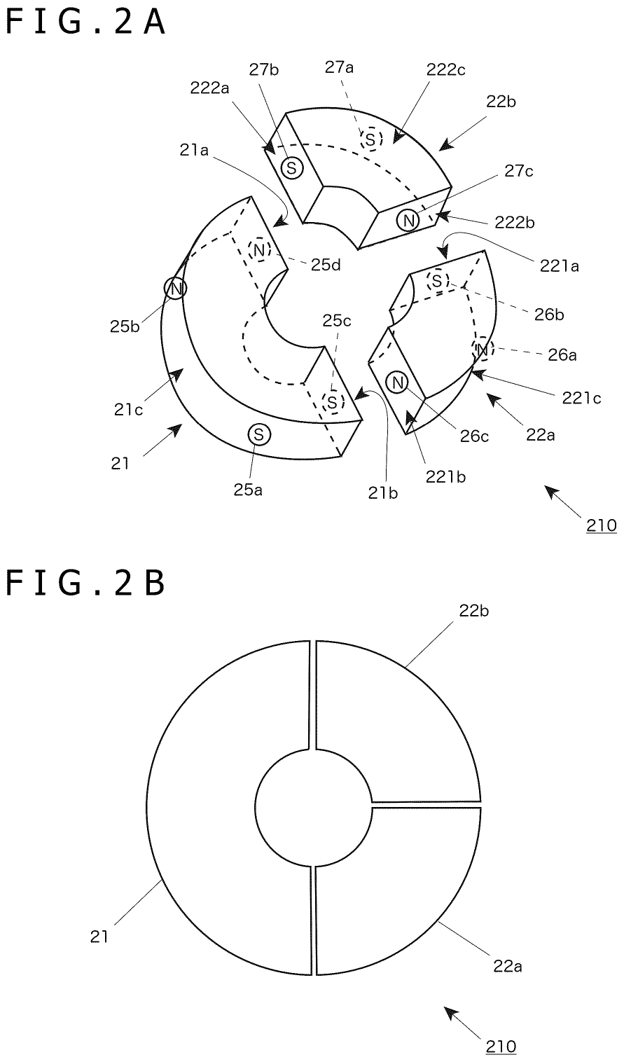

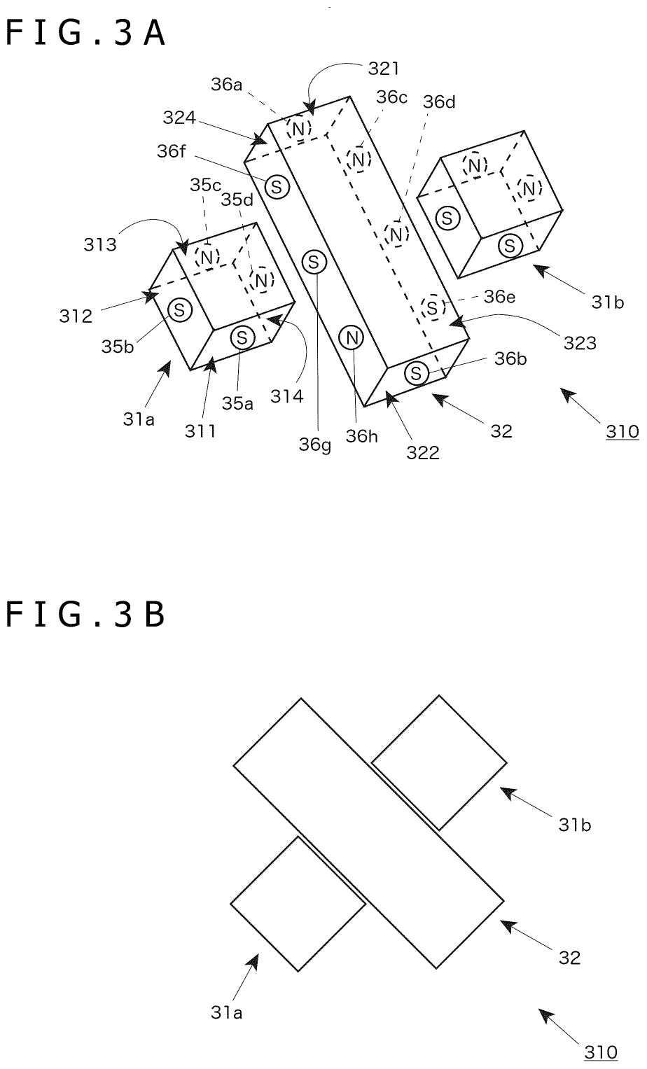

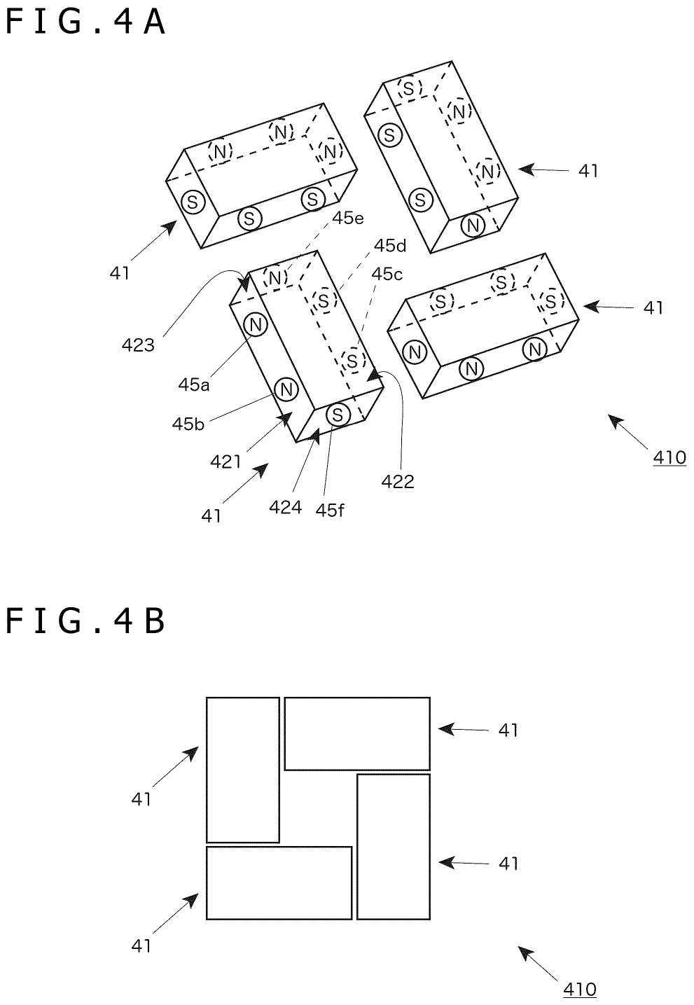

An embodiment of the present disclosure will now be described with reference to the accompanying drawings. In the following examples, it is assumed that the design motif of a product to be expressed includes a triangle, a circle, the letter X, and a rectangle. In the drawings used in the following explanation, the sizes and proportions of individual parts are merely for illustration purposes, and do not represent actual sizes and proportions. Further, for instance, the indication of sizes and proportions in the explanation is also merely an example, and may be modified within the spirit of the present disclosure. However, such an indication is merely an example, and different shapes will be described later. As illustrated in FIGS. 1A to 4B, a block set according to this example of the embodiment of the present disclosure includes (1) a trapezoidal block group 110 (FIGS. 1A and 1B) including three trapezoid-shaped blocks 11, (2) a fan-shaped block group 210 (FIGS. 2A and 2B) including a semicircular block 21 forming a fan-shaped semicircle and a pair of quarter fan-shaped blocks 22 forming quadrant circles, (3) a first rectangular block group 310 (FIGS. 3A and 3B) including a pair of smallest size blocks 31 having a cubic shape, with one side exceeding 2.5 cm, and one first rectangular parallelepiped block 32 having a size equivalent to three smallest size blocks that are lined up in a row, and (4) a second rectangular block group 410 (FIGS. 4A and 4B) including four second rectangular parallelepiped blocks 41 having a size equivalent to a pair of the smallest size blocks that are lined up in a row. Note that, in the following explanation, it is assumed that the length of one side of the smallest size block 31 is “a” (a>2.5 cm). It is also assumed that the letters N and S, which represent the poles of a permanent magnet in FIGS. 1A to 4B, indicate the poles facing outward from the blocks.

The trapezoidal block group 110 includes three isosceles trapezoidal columnar blocks 11 as illustrated in a perspective view in FIG. 1A. It is assumed that the relatively long side of the isosceles trapezoid surfaces (bottom surface and top surface) of the blocks 11 is regarded as the base, and that the base angle is 60 degrees, and further that the angle between the top side and the hypotenuse is 120 degrees. Moreover, as regards the surfaces of the isosceles trapezoid, it is assumed that the ratio of the length of the hypotenuse to the base of the isosceles trapezoid is ½. For example, it is assumed that the length of the base is 2a, and that the length of the hypotenuse is “a.” Hereinafter, the length “a” is referred to as a reference length. In this instance, the reference length is assumed to be a length exceeding 2.5 cm.

Moreover, at least one permanent magnet 12 (two permanent magnets 12a and 12b in FIG. 1A) having the N pole facing outward is disposed on the lateral surface of each of the blocks 11 that follows the base of the isosceles trapezoid. In addition, a permanent magnet 12c having the N pole facing outward is disposed on the lateral surface of each of the blocks 11 that follows one of the two hypotenuses of the isosceles trapezoid, and a permanent magnet 12d having the S pole facing outward is disposed on the lateral surface of each of the blocks 11 that follows the other hypotenuse. Further, a permanent magnet 12e having the S pole facing outward is disposed on the lateral surface of each of the blocks 11 that follows the top side of the isosceles trapezoid.

According to the above example, the trapezoidal block group 110 can be formed by combining the three blocks 11 to form a regular triangular prism with one side 3/2 times the size of the base of the above-described isosceles trapezoid (3a when the length of the base is 2) as illustrated in a plan view in FIG. 1B. In this instance, the blocks 11 are magnetically coupled to each other by the permanent magnets 12.

As illustrated in the perspective view in FIG. 2A, the fan-shaped block group 210 includes a semicircular block 21 forming a fan-shaped semicircle and two quarter fan-shaped blocks 22a and 22b forming quadrant circles. When there is no need to make a distinction between the quarter fan-shaped blocks 22a and 22b, they will hereinafter collectively be referred to as the quarter fan-shaped blocks 22.

The semicircular block 21 forming a fan-shaped semicircle has a bottom or top surface that is fan-shaped to form a semicircle having an inner diameter of a/2 and an outer diameter of 3a/2, which are based on the reference length “a” (the position corresponding to the center of this semicircle is hereinafter referred to as a virtual center), and has a columnar shape having a height equal to the reference length “a.” On a lateral surface 21c that is in contact with a curve on the outer diameter side of the semicircular block 21, a permanent magnet 25a having the S pole facing outward and a permanent magnet 25b having N pole facing outward are disposed at substantially equal distances from the center of the lateral surface 21c and at an angle of approximately 90 degrees around the above-described virtual center. Further, as regards two surfaces 21a and 21b of a square that is in contact with the straight-line portion of the bottom surface, a permanent magnet 25c having the S pole facing outward is disposed on the surface 21a, and a permanent magnet 25d having the N pole facing outward is disposed on the surface 21b.

The quarter fan-shaped blocks 22 have a bottom or top surface that is fan-shaped to form a quadrant circle having an inner diameter of a/2 and an outer diameter of 3a/2, which are based on the reference length “a,” and have a columnar shape having a height equal to the reference length “a.” A permanent magnet 26a having the S pole facing outward is disposed in the approximate center of a lateral surface 221c that is in contact with a curve on the outer diameter side of the quarter fan-shaped block 22a, which is one of the quarter fan-shaped blocks 22. Further, as regards two surfaces 221a and 221b of a square that is in contact with the straight-line portion of the bottom surface, a permanent magnet 26b having the S pole facing outward is disposed on the surface 221a, and a permanent magnet 26c having the N pole facing outward is disposed on the surface 221b.

Meanwhile, a permanent magnet 27a having the N pole facing outward is disposed in the approximate center of a lateral surface 222c that is in contact with a curve on the outer diameter side of the quarter fan-shaped block 22b. Further, as regards two surfaces 222a and 222b of a square that is in contact with the straight-line portion of the bottom surface, a permanent magnet 27b having the S pole facing outward is disposed on the surface 222a, and a permanent magnet 27c having the N pole facing outward is disposed on the surface 222b.

Stated differently, the present embodiment is configured such that the permanent magnets placed on the lateral surfaces 221c and 222c, which are in contact with the curves on the outer diameter side of the two quarter fan-shaped blocks 22, are disposed with opposite poles facing outward.

When the above-mentioned semicircular block 21 is combined with the two quarter fan-shaped blocks 22, a hollow cylindrical shape is formed as illustrated in a plan view in FIG. 2B, and the contacting surfaces of the semicircular block 21 and quarter fan-shaped blocks 22a and 22b are magnetically coupled to each other by the permanent magnets.

As illustrated in the perspective view in FIG. 3A, the first rectangular block group 310 includes a pair of smallest size blocks 31a and 31b and the first rectangular parallelepiped block 32. The smallest size blocks 31a and 31b each have a cubic shape having a size of a×a×a, which is based on the reference length “a,” with one side exceeding 2.5 cm. The first rectangular parallelepiped block 32 has a rectangular parallelepiped shape having a size equivalent to three smallest size blocks that are lined up in a row (i.e., a size of 3a×a×a). Note that, when there is no need to make a distinction between the smallest size blocks 31a and 31b, they will hereinafter collectively be referred to as the smallest size blocks 31.

The smallest size blocks 31 are structured such that permanent magnets 35a and 35b having the S poles facing outward are respectively disposed in the center of lateral surfaces 311 and 312, which are adjacent to each other, and that permanent magnets 35c and 35d having the N poles facing outward are respectively disposed in the center of lateral surfaces 313 and 314, which are respectively positioned opposite the lateral surfaces 311 and 312.

A permanent magnet 36a having the N pole facing outward is disposed on one surface 321 that is in contact with the short side of the bottom surface of the first rectangular parallelepiped block 32, and permanent magnets 36b and 36c having the N poles facing outward and a permanent magnet 36d having the S pole facing outward are disposed in this order at substantially equal intervals on one surface 322 that is in contact with the long side. In this instance, the permanent magnet 36c is disposed in such a manner as to be located at the center in the longitudinal direction.

Further, a permanent magnet 36e having the S pole facing outward is disposed on the other surface 323 that is in contact with the short side of the bottom surface of the first rectangular parallelepiped block 32, and permanent magnets 36f and 36g having the S poles facing outward and a permanent magnet 36h having the S pole facing outward are disposed in this order at substantially equal intervals on the other surface 324 that is in contact with the long side. In this instance, the permanent magnet 36g is disposed in such a manner as to be located at the center in the longitudinal direction.

Note that the permanent magnets disposed on the surfaces 322 and 324 are disposed in such a manner that their opposite poles face each other across the central axis extending in the longitudinal direction of the first rectangular parallelepiped block 32.

When the above-mentioned pair of smallest size blocks 31a and 31b are combined with the first rectangular parallelepiped block 32, a cross or the letter X is formed as illustrated in a plan view in FIG. 3B. In this instance, the contacting surfaces of the blocks are magnetically coupled to each other at their centers by the permanent magnets.

As illustrated in the perspective view in FIG. 4A, the second rectangular block group 410 includes the four second rectangular parallelepiped blocks 41 having a size equal to the size of two smallest size blocks 31 of the first rectangular block group 310 that are lined up in a row (i.e., having a size of 2a×a×a, which is based on the reference length a).

On one rectangular lateral surface 421, which is one of two rectangular lateral surfaces 421 and 422 of the above-mentioned second rectangular parallelepiped blocks 41, two permanent magnets 45a and 45b having the N poles facing outward are arranged in a row along the longitudinal direction of the second rectangular parallelepiped blocks 41. More specifically, the permanent magnets 45a and 45b are disposed, respectively, at a position ⅓ of the length 2a of the long side of the second rectangular parallelepiped blocks 41 from the end (i.e., 2a/3 away from the end) and at a position ⅔ of the length 2a of the long side of the second rectangular parallelepiped blocks 41 from the end (i.e., 4a/3 away from the end).

Further, on the other rectangular lateral surface 422, which is one of the two rectangular lateral surfaces 421 and 422, two permanent magnets 45c and 45d having the S poles facing outward are arranged in a row along the longitudinal direction of the second rectangular parallelepiped blocks 41. More specifically, the permanent magnets 45c and 45d are disposed, respectively, at a position ⅓ of the length 2a of the long side of the second rectangular parallelepiped blocks 41 from the end (i.e., 2a/3 away from the end) and at a position ⅔ of the length 2a of the long side of the second rectangular parallelepiped blocks 41 from the end (i.e., 4a/3 away from the end).

Further, a permanent magnet 45e having the N pole facing outward is disposed on one square lateral surface 423, which is one of two square lateral surfaces 423 and 424 of the second rectangular parallelepiped blocks 41, and a permanent magnet 45f having the S pole facing outward is disposed on the other square lateral surface 424.

When the above-mentioned four second rectangular parallelepiped blocks 41 are arranged to form a square whose one side is 3a as indicated in a plan view in FIG. 4B, a rectangle with an opening having a size of a×a is formed in the center. In this instance, the contacting surfaces of the blocks are magnetically coupled to each other at their centers by the permanent magnets.

In an example of the present embodiment, the blocks may be colored by use of first to fourth colors different from each other. The first color may be used to color the blocks included in the trapezoidal block group. The second color may be used to color the blocks included in the fan-shaped block group. The third color may be used to color the smallest size blocks and other blocks included in the first rectangular block group. The fourth color may be used to color the blocks included in the second rectangular block group. Alternatively, the same color may be used to color the blocks in all the block groups.

The above-mentioned four colors may be any colors as long as they are distinguishable from each other. For example, the first color is green, the second color is red, the third color is blue, and the fourth color is purple. Using such a coloring scheme makes it possible to clearly identify the block group to which the individual blocks belong. This makes it easy to return the blocks to their original shapes at the time of putting away and storing the blocks.

### Examples of Use

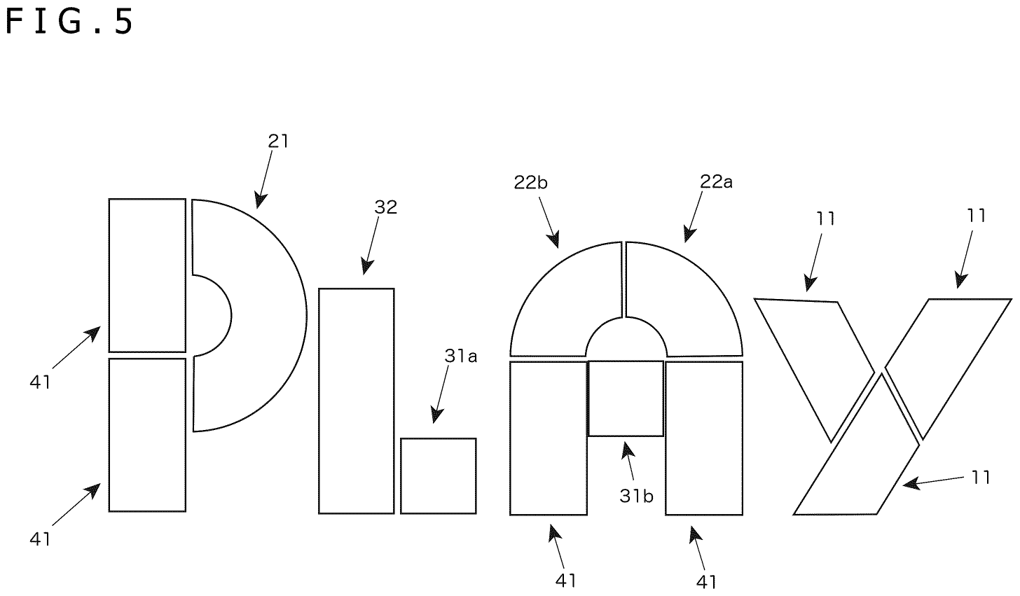

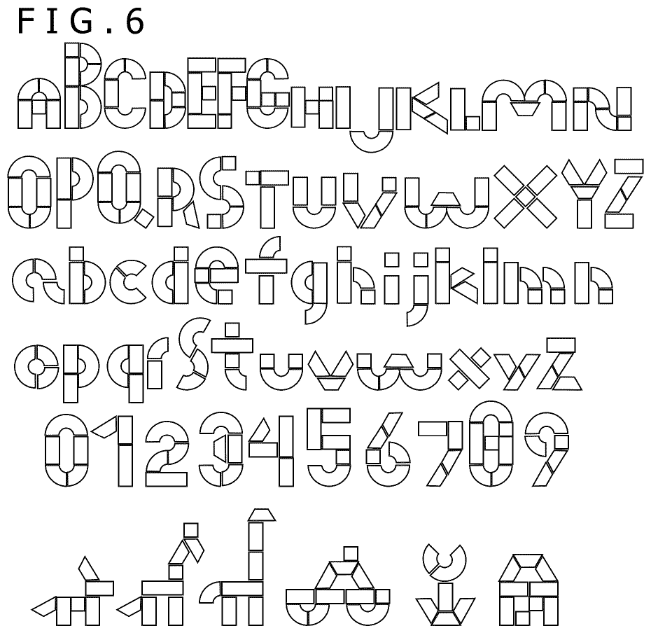

Using the block set according to the present embodiment makes it possible to represent alphabetical letters (uppercase and lowercase letters), numbers, or objects such as animals, vehicles, flowers, and houses (FIGS. 5 and 6). FIGS. 5 and 6 merely depict examples. Other combinations may be used to form various characters and shapes. In this manner, the present embodiment ensures that various expressions are possible with the block set, which includes a relatively small number of types, namely, 6 types and 13 pieces, and a relatively small number of blocks.

According to the present embodiment, the design motif of a product is expressed by a block group that can be divided into the smallest size blocks (one side should be 2.5 cm or more in the case of a cubic shape because 3.5 cm/√2 is less than 2.5 cm) that are larger than a virtual sphere having a diameter of 3.5 to prevent them from being accidentally ingested by infants (the standard for accidental ingestion is based on an international standard stating that a block will not pass through a cylindrical gauge having a diameter of 3.2 cm), and into blocks that are larger than the smallest size blocks. This makes it possible to prevent accidental ingestion and express, for example, the design motif of a product. Further, as described above, it is possible to divide a block into blocks of a size that will not accidentally be ingested, thereby making it possible to play with them by magnetically coupling them in different combinations. This additionally gives the effect of making the product's design motif familiar.

Note that, even if, for example, the design motif of the product to be expressed has a shape other than those illustrated above, it is sufficient to divide the shape of the design motif into at least symmetrical shapes (e.g., line symmetrical or point symmetrical), and to form the resulting shapes in such a manner that one side of a circumscribed rectangle exceeds 2.5 cm or that the diameter of a circumscribed sphere exceeds 3.5 cm.

Further, the present embodiment, the materials of blocks do not particularly matter. However, the blocks should preferably be formed by, for example, ordinary plastic or wood or other materials that are safely touchable and lickable (which will not dissolve).

### Three-dimensional Shape

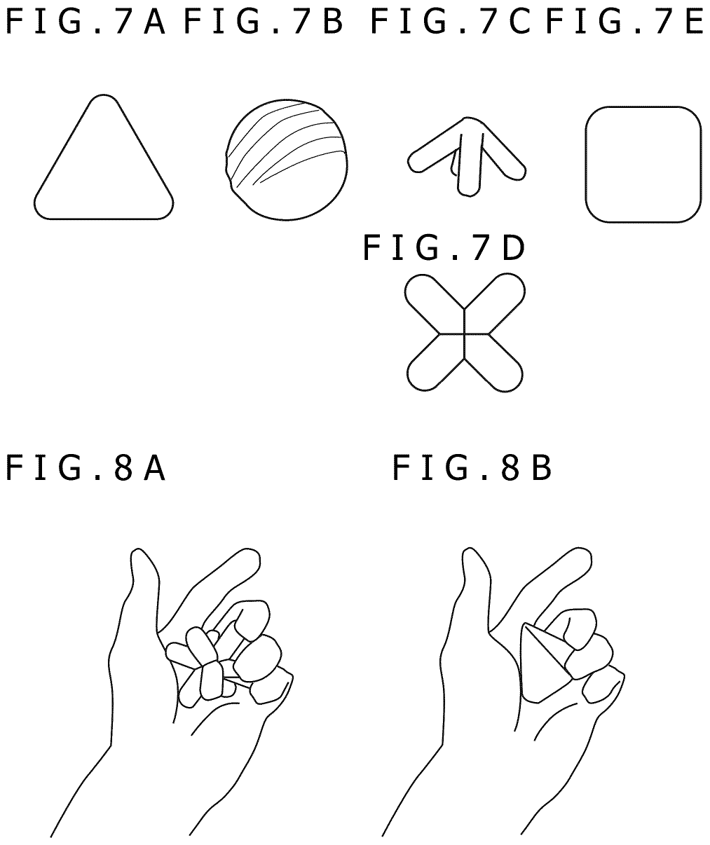

In addition, the design motif of the product may be expressed by a single three-dimensional block instead of a dividable block. In an example of the present embodiment, the block is shaped in such a manner that the design motif of a product emerges when viewed from a specific angle. Specifically, as is the case with the above example, when the design motif of the product to be expressed includes a triangle, a circle, the letter X, and a rectangle, the block may include a tetrahedron (whose pointed end may be rounded; FIG. 7A), a sphere (FIG. 7B), a block (whose end may be rounded; FIG. 7C) obtained by expressing the line segment of each side of a square pyramid except for the bottom surface (the square's bottom surface) by a slightly thin columnar body or may include a coupled block (whose end may be rounded; FIG. 7D) that is obtained by coupling the vertices of a pair of the above-mentioned blocks in such a manner that the radial directions of the sides match when viewed from a specific direction and a cube-shaped block (whose end may be rounded; FIG. 7E). FIGS. 7A to 7E present a perspective view of examples of these blocks.

A tetrahedron, a sphere, and a cube can be seen as a triangle, a circle, or a square, depending on the viewpoint. Moreover, a block obtained by forming each side of the square pyramid, excluding the bottom surface, through the use of columnar line segments can be seen as an X-shape when viewed from the axial direction centered on the relevant (imaginary) bottom surface. The coupled block formed by coupling a pair of blocks can be stood on the floor through the use of the four endpoints of the columnar line segments. Therefore, the X-shape can visually be recognized more easily.

### Other Examples of Size

Note that, in the above examples, if the product is intended for adults who are unlikely to accidentally ingest the product, one side of the circumscribed rectangle may be less than 2.5 cm, or the diameter of the circumscribed sphere may be less than 3.5 cm. In particular, if the diameter of the circumscribed sphere of a three-dimensional shape is less than 3.5 cm, the blocks shaped as illustrated in FIGS. 7A to 7E may be formed by, for example, silicon with suitable hardness and sized to fit in a hand of a user as depicted in FIG. 8A and FIG. 8B. This makes it possible to use the blocks in an application where a part of the palm of the hand is to be stimulated by tips or ends of the blocks, for example. In this instance, the hardness should preferably be experimentally determined in such a manner that the user does not feel pain and can feel stimulated by a massage when the user grips the blocks. FIG. 8A illustrates a state in which the block shaped as depicted in FIG. 7D is gripped. FIG. 8B illustrates a state in which the block shaped as depicted in FIG. 7A is gripped. Further, the above-mentioned blocks may each be shaped with shallow bumps and dips formed on the surface such that each of blocks fits to the fingers when the fingers are placed on them. For example, in a case where a sphere is shaped with bumps and dips formed as depicted in FIG. 7B, the sphere can stably be gripped because the fingers fit with the bumps and dips when the sphere is grasped by the hand.

It should be understood by those skilled in the art that various modifications, combinations, sub-combinations and alterations may occur depending on design requirements and other factors insofar as they are within the scope of the appended claims or the equivalents thereof.

1. A block set comprising:
a smallest size block that has a cubic shape, with one side exceeding 2.5 cm; and
a plurality of blocks that have a larger volume than the smallest size block, are circumscribed by a rectangle with a minimum side exceeding 2.5 cm, and have a same height from a bottom surface to a top surface,
wherein the smallest size block and the blocks each have a plurality of magnets that are disposed on lateral surfaces with different poles facing outward.

2. The block set according to claim 1,
wherein the blocks include
a trapezoidal block group that is a group of three trapezoid-shaped blocks which are able to be combined to form a triangle,
a fan-shaped block group that includes a semicircular block forming a fan-shaped semicircle and a pair of quarter fan-shaped blocks forming quadrant circles which are able to be combined to form a hollow cylindrical shape,
a first rectangular block group that includes a pair of the smallest size blocks and one first rectangular parallelepiped block having a size equivalent to three smallest size blocks that are lined up in a row, and
a second rectangular block group that includes four second rectangular parallelepiped blocks having a size equivalent to a pair of the smallest size blocks that are lined up in a row, and
colors different from each other are used in which,
the blocks included in the trapezoidal block group are colored a first color,
the blocks included in the fan-shaped block group are colored a second color,
the smallest size blocks and the block included in the first rectangular block group are colored a third color, and
the blocks included in the second rectangular block group are colored a fourth color.
